(19) United States
(12) Patent Application Publication
(10) Pub. No.: US 2005/0214429 A1
(43) Pub. Date: Sep. 29, 2005

(54) Aerated confections and methods for preparing the same

(75) Inventors: Jon Kevin Anderson, Napa, CA (US); Jack C. Grosskopf, Ocala, FL (US); Shirley Duke, Ocala, FL (US)

Correspondence Address: CARPENTER & KULAS, LLP, 1900 EMBARCADERO ROAD, SUITE 109, PALO ALTO, CA, 94303, US

(73) Assignee: Wham-O, Emeryville, CA (US)

(21) Appl. No.: 10/808,235

(22) Filed: Mar. 24, 2004

(51) Int. Cl. A23G 1/00

(52) U.S. Cl. 426/564

(57) ABSTRACT

A dry particulate food composition comprising a gelling agent, at least one protein, at least one binding agent, at least one sweetening agent, a chemical gassing agent, and a chemical reagent for controlling and increasing a quantity of chemical gas released from the chemical gassing agent. The dry particulate food composition may additionally include at least one flavoring agent, at least one bulking agent, and at least one coloring agent. The dry particulate food composition may be mixed with a liquid to produce a food product.

### FIELD OF THE INVENTION

Embodiments of the present invention generally broadly relate to food products and to methods for producing food products. More specifically, embodiments of the present invention generally provide for aerated confections (e.g., marshmallow products or nougat) and for dry food compositions (e.g., dehydrated food compositions in particulate form) which are capable of producing food products when admixed with water or any other suitable liquid (e.g., fruit juices, etc). More specifically further, additional embodiments of the present invention generally provide methods for producing aerated confections and for producing dry food compositions.

### BACKGROUND OF THE INVENTION

The basic method for the production of marshmallow as it is known today was first shown in U.S. Pat. No. 2,600,569 to E. T. Oakes in 1952. This invention was the first showing of the injection of gas into a marshmallow mix to cause it to puff upon release of gas pressure and form an aerated confection.

Even though since that time many patents have issued showing different additions to marshmallow and improvements in producing marshmallows, such aerated confections are still difficult to prepare when compared to other food products. Aerated confections, particularly marshmallows, typically require the heating or cooking of a proper blend of crystallized and dissolved carbohydrates in conjunction with a whipping agent, such as egg whites, gelatin, or vegetable protein.

Accordingly, a need exists for the effective and efficient preparation of aerated confections, such as marshmallow or nougat, and the like. More specifically, and accordingly further, a need also exists for the effective and efficient preparation of aerated confections without having to employ external heating or cooking to produce the aerated confections.

### SUMMARY OF EMBODIMENTS OF THE INVENTION

Embodiments of the present invention provide a dry particulate food composition comprising a gelling agent, at least one protein, at least one sweetening agent, at least one binding agent, a chemical gassing agent, and a chemical reagent for controlling and increasing a quantity of chemical gas released from the chemical gassing agent. The dry particulate food composition may additionally include at least one flavoring agent, at least one bulking agent, and at least one coloring agent.

Embodiments of the present invention also provide a method for producing a food product comprising providing a dry particulate food composition including a gelling agent, at least one protein, at least one sweetening agent, a chemical gassing agent, at least one binding agent, and a chemical reagent for controlling and increasing a quantity of chemical gas released from the chemical gassing agent; and adding the dry particulate food composition to a liquid to produce a food product. The liquid comprises a temperature ranging from about 105° F. to about 120° F. The method additionally comprises producing the food product without employing external heat.

Embodiments of the present invention further also provide a method for producing a food product comprising providing a dry particulate food composition including a gelling agent, at least one protein, at least one sweetening agent, at least one binding agent, and a chemical reagent for controlling and increasing a quantity of chemical gas released from a chemical gassing agent; adding the dry particulate food composition to a liquid to produce a liquid food mixture; and adding a chemical gassing agent to the liquid food mixture to produce a food product.

Embodiments of the present invention further provide a method for producing a food composition comprising providing particulates of a sweetening agent and particulates of an agent for controlling the release of chemical gas from a chemical gassing agent, separating from the sweetening particulates particles having an average particle size less than about 600 μM to produce separated sweetening particles, separating from the agent for controlling the release of chemical gas particulates having an average particle size less than about 600 μM to produce separated agent particles, and mixing the separated agent particles with the separated sweetening particles together to produce a food composition.

Embodiments of the present invention also provide a dry food composition comprising a plurality of particulates having an average particle size less than about 600 μM and including a gelling agent, at least one protein, at least one sweetening agent, at least one binding agent, a chemical gassing agent, and a chemical reagent for controlling and increasing a quantity of chemical gas released from the chemical gassing agent.

These provisions together with the various ancillary provisions and features which will become apparent to those skilled in the art as the following description proceeds, are attained by the methods and food products (e.g., aerated confections, dry food compositions, etc.) of the present invention.

### DETAILED DESCRIPTION OF PREFERRED EMBODIMENTS OF THE INVENTION

Embodiments of the present invention broadly include food products, preferably aerated confections, such as marshmallow food products. Embodiments of the present invention further broadly include methods for forming, producing or preparing food products. Embodiments of the present invention also further broadly include methods for preparing or producing a dry food composition, preferably a dry food composition in particulate(s) form, which may be employed to prepare or produce food products by the addition of a liquid, such as water or any fruit juice.

Embodiments of the present invention include a dry food composition comprising a chemical reagent for controlling and increasing the quantity of chemical gas released from a chemical gassing agent. Preferably, in addition to the chemical reagent and the chemical gassing agent, the dry food composition additionally comprises one or more of the following food components: a gelling agent, at least one protein, at least one sweetening agent, at least one binding agent, a filler or bulking agent, at least one flavoring agent, and at least one coloring agent. The foregoing food components are preferably dry solids, more preferably in particulate form.

In various embodiments of the invention one or more of the foregoing food components are preferably “cold water components,” which are soluble in any suitable liquid (e.g., water, a juice, etc) without the necessity of employing external heat, such as by cooking the food component(s) in any suitable liquid at a temperature above 170° F. Thus, alternatively for various embodiments of the invention, a cold water component (e.g., a cold water gelling agent, such as gelatin) is soluble in water (or any other suitable liquid) having a temperature equal to or less than about 170° F. (e.g., a temperature ranging from about 60° F. to about 170° F.), more preferably equal to or less than about 130° F. (e.g., a temperature ranging from about 80° F. to about 130° F.), most preferably equal to or less than about 120° F. (e.g., a temperature ranging from about 100° F. to about 120° F., including a temperature ranging from about 105° F. to about 120° F., such as from about 110° F. to about 115° F.).

Therefore, for various embodiments of the invention, when the dry food composition is to be dissolved in a suitable liquid to prepare a food product, the dry food composition is admixed with the suitable liquid without employing external heat (e.g., cooking), and with the suitable liquid having a temperature equal to or less than about 170° F. (e.g., a temperature ranging from about 60° F. to about 170° F.), more preferably equal to or less than about 130° F. (e.g., a temperature ranging from about 80° F. to about 130° F.), most preferably equal to or less than about 120° F. (e.g., a temperature ranging from about 100° F. to about 120° F., including a temperature ranging from about 105° F. to about 120° F., such as from about 110° F. to about 115° F.)

One or more of the food components in the dry food composition may be in particulate form having a generally uniform particle size. More specifically, one or more of the food components (e.g., the sweetening agent(s), the chemical reagent, etc) in the dry food composition are preferably in particulate form having an average particle size (i.e., the distance across a particle's greatest cross-sectional area) of less than about 600 pm (i.e., less that about 0.0234 inches); preferably less than about 300 pm (i.e., less than about 0.0117 inches), such as from about 106 μm (i.e., about 0.004 inches) to about 150 μm (i.e., about 0.006 inches). Stated alternatively and for various embodiments of the present invention, a majority of the particulates for any one or more of the food components in the dry food composition have an average particle size (i.e., the distance across a particle's greatest cross-sectional area) of less than about 600 μm (i.e., less than about 0.0234 inches); preferably less than about 300 μm (i.e., less than about 0.0117 inches), such as from about 106 μm (i.e., about 0.004 inches) to about 150 μm (i.e., about 0.006 inches).

For various embodiments of the present invention essentially all of the respective food components in the dry food composition have an average particle size of less than about 600 μm; preferably less than about 300 μm, such as from about 106 μm to about 150 μm. Stated alternatively and for various embodiments of the present invention, a majority of the particulates for essentially all of the respective food components in the dry food composition have an average particle size of less than about 600 μm, preferably less than about 300 μm, such as from about 106 μm to about 150 μm.

It has been discovered that particulates for the food components having a generally uniform particles size, particularly generally having the previously mentioned particle size(s), produces a food product having a better texture (i.e., no grittiness) and improved performance (i.e., better expansion from aeration). The previously mentioned particle size(s) for the food components enables the associated particulates to be more uniformly distributed and/or disseminated. Any oversized particulates of any food component may be conveniently reduced in size in accordance with any well known procedure, such as by milling. Oversized particles may be determined and removed by passing the particulates of any food component through the openings of a screen of a U.S.A. Standard Test Sieve.

Broadly, the preparation of a food product in accordance with embodiments of the invention comprises the steps of mixing the dry food composition with a liquid, such as water or any fruit juice. The mixture of the liquid and the dry food composition comprises at least about 30% by weight of the liquid, such as from about 30% by weight to about 60% by weight. Preferably, the mixture of the liquid and the dry food composition comprises at least about 35% by weight of the liquid, such as from about 35% by weight to about 55% by weight, more preferably at least about 38% by weight of the liquid, such as from about 38% by weight to about 46% by weight of the liquid or from about 40% by weight to about 44% by weight of the liquid. For various embodiments of the invention, a portion of the dry food composition is initially mixed with the liquid until dissolved and/or mixed to produce an initial liquid food mixture, followed then by admixing a remaining portion of the dry food composition with the initial liquid food mixture. The dry food composition is typically divided up and stored in hermetically sealed packets until ready for use.

The gelling agent for various embodiments of the present invention may be any suitable gelatinous material (i.e., a structuring or gelling agent) which is capable of assisting in the function of structuring or gelling a food product during preparation of the food product. The gelling agent preferably comprises gelatin, which may include a glutinous material obtained from animal tissue(s) or bones (e.g., pork bone) by prolonged boiling, or any of the various substances resembling gelatin in physical properties. Gelatin may include a solid on the basis of bloom test or jelly strength test.

The gelatin for various embodiments of the invention has a bloom test ranging from about 150 grams to about 400 grams with variations in the bloom test values being compensated for by using less gelatin as the bloom test values increases. The gelatin includes a bloom test greater than about 250 grams, preferably greater than about 250 grams but less than or equal to about 300 grams; more preferably, from about 260 grams to about 290 grams; most preferably from about 275 grams to about 285 grams (e.g., such as about 280 grams).

The dry food composition comprises at least about 3% by weight gelling agent (e.g., gelatin) based upon the total weight of the dry food composition taken as 100% by weight. Preferably, the food product comprises at least about 5% by weight gelling agent, such as from about 5.0% by weight to about 15.0% by weight, based upon the total weight of the dry food composition taken as 100% by weight. More preferably, the dry food composition comprises at least about 7.0% by weight gelling agent, such as from about 7.0% by weight to about 10.0% by weight, based upon the total weight of the dry food composition taken as 100% by weight. Most preferably, the dry food composition comprises at least about 8.5% by weight gelling agent, such as from about 8.5% by weight to about 9.5% by weight (e.g., from about 8.9% by weight to about 9.3% by weight or from about 9.0% by weight to about 9.20% by weight), based upon the total weight of the dry food composition taken as 100% by weight.

For various embodiments of the present invention, the gelling agent is preferably a gelling agent (i.e., a cold water gelling agent) which is soluble in water (or any other suitable liquid) having a temperature equal to or less than about 170° F. (e.g., a temperature ranging from about 60° F. to about 170° F.), more preferably equal to or less than about 130° F. (e.g., a temperature ranging from about 80° F. to about 130° F.), most preferably equal to or less than about 120° F. (e.g., a temperature ranging from about 100° F. to about 120° F., including a temperature ranging from about 105° F. to about 120° F., such as from about 110° F. to about 115° F.). The gelling agent for various embodiments of the present invention is a gelling agent which is soluble in water (or any other suitable liquid) without the necessity of employing any external heat (e.g., cooking, such as to a temperature ranging from about 175° F. to boiling) to dissolve the gelling agent, or make the gelling agent soluble, in water. A suitable gelling agent comprises a gelatin which may be purchased commercially from PB Leiner of Davenport, Iowa under the product name Cryogel FG/3 P. While a suitable gelling agent (e.g., a gelling component) comprises gelatin for various embodiments of the present invention, it is to be understood that the spirit and scope of the present invention may include other gelling agents which may be capable of providing the same function and results as gelatin, such as, by way of example only and not by limitation, pectin, modified starches, albumen, gums, and mixtures thereof.

The dry food composition for various embodiments of the invention preferably includes at least one protein, such as one or more proteins selected from the group consisting of whey protein, soy protein, and egg white (i.e., egg albumen). The total protein present in the dry food composition is preferably at least about 2.0% by weight, such as from about 2.0% by weight to about 25.0% by weight, based upon the total weight of the dry food composition taken as 100% by weight. More preferably, the dry food composition comprises at least about 4.0% by weight total protein, such as from about 4.0% by weight to about 20.0% by weight, based upon the total weight of the dry food composition taken as 100% by weight. Most preferably, the dry food composition comprises at least about 10.0% by weight total protein, such as from about 10.0% by weight to about 18.0% by weight (e.g., from about 12.0% by weight to about 16.5% by weight, or from about 13.0% by weight to about 15.0% by weight, or from about 14.0% by weight to about 14.8% by weight), based upon the total weight of the dry food composition taken as 100% by weight.

For various embodiments of the invention, the dry food composition more preferably comprises whey protein isolate and egg albumen. The amount or quantity of whey protein isolate present in the dry food composition is preferably at least about 1.0% by weight, such as from about 1.0% by weight to about 10.0% by weight, based upon the total weight of the dry food composition taken as 100% by weight. More preferably, the dry food composition comprises at least about 2.0% by weight whey protein isolate, such as from about 2.0% by weight to about 8.0% by weight, based upon the total weight of the dry food composition taken as 100% by weight. Most preferably, the dry food composition comprises at least about 3.5% by weight whey protein isolate, such as from about 3.5% by weight to about 6.0% by weight (e.g., from about 4.0% by weight to about 5.5% by weight or from about 4.5% by weight to about 5.1% by weight), based upon the total weight of the dry food composition taken as 100% by weight. A suitable whey protein isolate may be purchased commercially from Clofine Dairy & Food Products Incorporated of Linwood, N.J., under the product name Whey Protein Isolate.

The amount or quantity of egg albumen present in the dry food composition is preferably at least about 1.0% by weight, such as from about 1.0% by weight to about 15.0% by weight, based upon the total weight of the dry food composition taken as 100% by weight. More preferably, the dry food composition comprises at least about 2.0% by weight egg albumen, such as from about 2.0% by weight to about 12.0% by weight, based upon the total weight of the dry food composition taken as 100% by weight. Most preferably, the dry food composition comprises at least about 8.0% by weight egg albumen, such as from about 8.0% by weight to about 11.0% by weight (e.g., from about 8.5% by weight to about 10.5% by weight or from about 9.0% by weight to about 10.0% by weight), based upon the total weight of the dry food composition taken as 100% by weight. A suitable egg albumen may be purchased commercially from Ballas Egg Products Corporation of Zanesville, Ohio under the product name Ballas Egg Spray-Dried Albumen: Type H-40.

We have discovered that there are advantages in combining egg albumen with whey protein isolate, as opposed to combining egg albumen with another protein, or combining whey protein isolate with another protein. We have discovered that using whey protein isolate by itself does not produce a strong, stable foam structure, and the final product tends to exhibit syneresis after demolding and a pronounced undesirable, “milky” aftertaste. Furthermore, the product does not release as well from the mold as when whey protein isolate is combined with egg albumen in a suitable ratio, such as a whey protein isolate to egg albumen weight ratio ranging from about 1:1 to about 1:3, more preferably from about 1:1.5 to about 1:2.5, most preferably from about 1:1.8 to about 1:2.2 (e.g., about 1:2). We have further discovered that using soy protein by itself produces a weak, unstable foam structure that is soft and tacky to the touch with the final product exhibiting weeping after demolding and a harsh, undesirable, soy flavor. Using whey protein isolate with soy protein initially produces a stable foam structure. Once the final product is chilled, however, it will “fall”, releasing the gas generated by the chemical reaction. The “deflated” product will not release from the mold, is tacky to the touch, and exhibits syneresis. The off-flavor from the combined proteins in the product is less intense than using either protein by itself. However, the flavor profile is still unacceptable. We have also further discovered as indicated that using whey protein isolate with egg albumen produces a strong, stable foam. The resulting product does not shrink after chilling, is firm and smooth to the touch, exhibits no weeping, releases easily/completely from the mold, and possesses an acceptable flavor. In an embodiment of the present invention, the egg albumen comprises at least about 80% by weight protein. It has been discovered that an improved food product is produced when the egg albumen comprises greater than (or equal to) about 80% by weight protein.

The dry food composition preferably comprises a chemical reagent for controlling and increasing the release of chemical gas from the chemical gassing agent. The chemical reagent for controlling and increasing the release of chemical gas initiates (e.g., chemically initiates) the release of chemical gas from the chemical gassing agent, while increasing (i.e., chemically increasing) the quantity of chemical gas released from the chemical gassing agent. Preferably, the chemical reagent is selective in its chemical initiation in that the chemical reagent will react or interact with the chemical gassing agent (i.e., reacting or interacting with essentially only the chemical gassing agent) and will not essentially or significantly react, interact, or combine with the other components or ingredients of the food product to produce undesirable by-products.

The chemical reagent may be any suitable chemical reagent which is capable of reacting, interacting, or combining with the chemical gassing agent for controlling and increasing the release of chemical gas from the chemical gassing agent for aerating and expanding the food product. For various embodiments of the invention the chemical reagent comprises malic acid. The chemical reagent may also comprise an acid selected from the group of acids consisting of tartaric, lactic, citric, succinic, adipic, fumaric, phosphoric, and mixtures thereof.

The amount or quantity of the chemical reagent present in the dry food composition preferably comprises at least about 0.1% by weight, such as from about 0.1% by weight to about 4.0% by weight, based upon the total weight of the dry food composition taken as 100% by weight. More preferably, the dry food composition comprises at least about 0.3% by weight of the chemical reagent, such as from about 0.3% by weight to about 3.0% by weight, based upon the total weight of the dry food composition taken as 100% by weight. Most preferably, the dry food composition comprises at least about 0.70% by weight of the chemical reagent, such as from about 0.70% by weight to about 1.25% by weight (e.g., from about 0.80% by weight to about 1.1% by weight or from about 0.90% by weight to about 1.1% by weight), based upon the total weight of the dry food composition taken as 100% by weight. As indicated, the chemical reagent preferably comprises malic acid, which may be purchased commercially from Bartek Ingredients Inc. of Stoney Creek, Ontario, Canada, under the product name Bartek Malic Acid Regular Grade, FCC, C.A.S. No. 6915-15-7, E.C. Number 296.

The dry food composition preferably comprises a chemical gassing agent for releasing controlled chemical gassing (i.e., controlled aeration) for expanding a mixture of the dry food composition and a liquid into the food product (e.g., for expanding the marshmallow product). The chemical gas released by the chemical gassing agent is controlled and increased by the chemical reagent. As indicated, the chemical reagent for controlling and increasing the release of chemical gas initiates (e.g., chemically initiates) the release of chemical gas while increasing the quantity of chemical gas released from the chemical gassing agent, and while being selective in chemical initiation in that the chemical reagent does not combine with or react with the other components or ingredients of food product to produce undesirable by-products.

The chemical gassing agent may be any suitable gassing agent which is capable of interacting with the chemical reagent for controlling and increasing the release of chemical gas, and capable of aerating a mixture of the dry food composition and a liquid for expanding the mixture of the dry food composition and liquid into the food product. For various embodiments of the invention the chemical gassing agent comprises a salt which is capable of releasing bubbles of chemical gas when coming in contact with certain constituents of the food product, particularly water and the chemical reagent. The salt is preferably a carbonate salt or a phosphate salt. For various embodiments of the present invention, the chemical gassing agent may comprise sodium bicarbonate or monocalcium phosphate, or a mixture thereof. The chemical gassing agent may also be selected from the group consisting of potassium bicarbonate, ammonia carbonate, sodium aluminum phosphate, dry yeast, and mixtures thereof. More preferably, the chemical gassing agent comprises sodium bicarbonate.

The amount or quantity of the chemical gassing agent (e.g., sodium bicarbonate) present in the dry food composition preferably comprises at least about 0.2% by weight, such as from about 0.2% by weight to about 8.0% by weight, based upon the total weight of the dry food composition taken as 100% by weight. More preferably, the dry food composition comprises at least about 1.5% by weight chemical gassing agent, such as from about 1.5% by weight to about 4.0% by weight, based upon the total weight of the dry food composition taken as 100% by weight. Most preferably, the dry food composition comprises at least about 2.0% by weight of the chemical gassing agent, such as from about 2.0% by weight to about 2.6% by weight (e.g., from about 2.2% by weight to about 2.6% by weight), based upon the total weight of the dry food composition taken as 100% by weight. The chemical gassing agent preferably comprises sodium bicarbonate, which. may be purchased commercially from Ashland Chemical of Knoxville, Tenn., under the product name sodium bicarbonate.

The dry food composition preferably additionally comprises a binding agent. More preferably, the dry food composition comprises a binding agent (i.e., a cold water binding agent) which is soluble in water (or any other suitable liquid) having a temperature equal to or less than about 170° F. (e.g., a temperature ranging from about 60° F. to about 170° F.), more preferably equal to or less than about 130° F. (e.g., a temperature ranging from about 80° F. to about 130° F.), most preferably equal to or less than about 120° F. (e.g., a temperature ranging from about 100° F. to about 120° F., including a temperature ranging from about 105° F. to about 120° F., such as from about 110° F. to about 115° F.). The binding agent for various embodiments of the present invention is a binding agent which is soluble in water (or any other suitable liquid) without the necessity of employing any external heat (e.g., cooking, such as to a temperature ranging from about 175° F. in proximity to boiling) to dissolve the binding agent, or make the binding agent soluble, in water, while simultaneously allowing or permitting the binding agent to bind or conglomerate the ingredients of food product when added to or in a liquid, such as water. For various embodiments of the invention the binding agent comprises a carbohydrate, preferably a polysaccharide, such as a polysaccharide having a combination of nine or more monosaccharide, linked together by glycosidic bonds (e.g., dextrins, starch groups, cellulose groups, glycogen groups, etc). More preferably, the binding agent comprises starch (e.g., a carbohydrate polymer).

The amount or quantity of the binding agent present in the dry food composition preferably comprises at least about 1.0% by weight, such as from about 1.0% by weight to about 15.0% by weight, based upon the total weight of the dry food composition taken as 100% by weight. More preferably, the dry food composition comprises at least about 2.0% by weight binding agent, such as from about 2.0% by weight to about 10.0% by weight, based upon the total weight of the dry food composition taken as 100% by weight. Most preferably, the dry food composition comprises at least about 5.0% by weight binding agent, such as from about 5.0% by weight to about 9.0% by weight (e.g., from about 6.0% by weight to about 8.0% by weight or from about 7.0% by weight to about 7.5% by weight), based upon the total weight of the dry food composition taken as 100% by weight. A suitable binding agent may be purchased commercially from AVEBE America, Inc. of Princeton, N.J., under the product name PASELLI™ EZ 2030, which is a cold water soluble starch comprising a tapioca starch (i.e., a modified tapioca starch).

The dry food composition preferably comprises at least one sweetening agent, such as at least one saccharide component comprising one or more of the following: monosaccharide sugars or disaccharide sugars, such as by way of example only, glucose, sucrose, fructose, dextrose (e.g., anhydrous, monohydrate or dextrose syrup), levilose, sorbitol, and hydrogenated disaccharides, such as maltitol or any other suitable saccharide alcohol(s). The total sweetening agent(s) present in the dry food composition preferably comprises at least about 20% by weight, such as from about 20% by weight to about 80% by weight, based on the total weight of the dry food composition as 100%. More preferably, the dry food composition comprises at least about 30% by weight total sweetening agent(s), such as from about 30% by weight to about 70% by weight, based on the total weight of the dry food composition taken as 100% by weight. Most preferably, the dry food composition comprises at least about 40% by weight total sweetening agent(s), such as from about 40% by weight to about 60% by weight (e.g., from about 45% by weight to about 55% by weight), based on the total weight of the dry food composition taken as 100% by weight.

For various embodiments of the invention, the dry food composition more preferably comprises a first sweetening component and a second sweetening component. The amount or quantity of the first sweetening component present in the dry food composition preferably comprises at least about 10.0% by weight, such as from about 10.0% by weight to about 40.0% by weight, based upon the total weight of the dry food composition taken as 100% by weight. More preferably, the dry food composition comprises at least about 20.0% by weight first sweetening component, such as from about 20.0% by weight to about 35.0% by weight, based upon the total weight of the dry food composition taken as 100% by weight. Most preferably, the dry food composition comprises at least about 25.0% by weight first sweetening component, such as from about 25.0% by weight to about 30.0% by weight (e.g., from about 26.0% by weight to about 29.0% by weight or from about 27.0% by weight to about 28.0% by weight), based upon the total weight of the dry food composition taken as 100% by weight. A suitable first sweetening component comprises sucrose and may be purchased commercially from United Sugars™ Corporation, 524 Center Avenue, Moorhead, Minn. 56560, under the product name Extra Fine Granulated (EFG) Sugar.

The amount or quantity of the second sweetening component present in the dry food composition preferably comprises at least about 10.0% by weight, such as from about 10.0% by weight to about 40.0% by weight, based upon the total weight of the dry food composition taken as 100% by weight. More preferably, the dry food composition comprises at least about 15.0% by weight second sweetening component, such as from about 15.0% by weight to about 30.0% by weight, based upon the total weight of the dry food composition taken as 100% by weight. Most preferably, the dry food composition comprises at least about 20.0% by weight second sweetening component, such as from about 20.0% by weight to about 25.0% by weight (e.g., from about 20.0% by weight to about 24.0% by weight or from about 21.0% by weight to about 23.0% by weight), based upon the total weight of the dry food composition taken as 100% by weight. A suitable second sweetening component comprises fructose and may be purchased commercially from A.E. Staley Manufacturing Company of Decatur, Ill., under the product name KRYSTAR® 300 Crystalline Fructose.

The dry food composition may additionally comprise a filler or bulking agent, such as sorbitol, xylitol and hydrolyzed starch syrups (e.g., corn syrups) which includes one or more of the following: dextrin, maltose and dextrose. The filler or bulking agent may also function as a further saacharide or sweetening component. The amount or quantity of the filler or bulking agent present in the dry food composition preferably comprises at least about 4.0% by weight, such as from about 4.0% by weight to about 30.0% by weight, based upon the total weight of the dry food composition taken as 100% by weight. More preferably, the dry food composition comprises at least about 8.0% by weight filler or bulking agent, such as from about 8.0% by weight to about 24.0% by weight, based upon the total weight of the dry food composition taken as 100% by weight. Most preferably, the dry food composition comprises at least about 10.0% by weight filler or bulking agent, such as from about 10.0% by weight to about 15.0% by weight (e.g., from about 11.0% by weight to about 14.0% by weight or from about 12.0% by weight to about 13.0% by weight), based upon the total weight of the dry food composition taken as 100% by weight. A suitable filler or bulking agent comprises corn syrup (i.e., corn syrup solids) which may be purchased commercially from Roquette America, Inc. 1417 Exchange Street, Keokuk, Iowa 52632-6647, under the product name DRI-SWEET® GRANULATED FINE.

In addition to, or as an alternative to, the saccharide component, the food product may include an artificial sweetener, such as sodium, calcium or ammonium saccharin salts, dihydrochalcones, glycyrrhizin, dipotassium glychyrrhizin, glycyrrhizic acid ammonium salt, L-aspartyl-L-phenylalanine methyl ester, as well as Stevia rebaudiana (Stevioside), Richardella dulcifica (Miracle Berry), Dioscoreophyllum cumminsii (Serendipidity Berry), acesulfame potassium, cyclamate salts, and the like, or mixtues of any two or more of the foregoing. The artificial sweetener may comprise aspartame, such as that sold under the trademark Equal™ or Nutrasweet™.

The dry food composition may comprise at least one coloring agent for providing a suitable color to the food product. The color provided to the dry food composition may be any color, including white and various hues or shades (e.g., pink and red). The coloring agent may be any suitable coloring agent which is capable of providing a desired color (e.g., white, yellow, pink, etc) to the food product when produced by admixing the dry food composition with a suitable liquid. The coloring agent may comprise titanium dioxide. The coloring agent may be an artifical colorant (e.g., FD&C dyes+lakes), or any other naturally FDA approved colorants (e.g., beet powder, turmeric, paprika, etc.).

The amount or quantity of the coloring agent in the dry food composition preferably comprises at least about 0.4% by weight, such as from about 0.4% by weight to about 8.0% by weight, based upon the total weight of the dry food composition taken as 100% by weight. More preferably, the dry food composition comprises at least about 1.2% by weight coloring agent, such as from about 1.2% by weight to about 6.0% by weight, based upon the total weight of the dry food composition taken as 100% by weight. Most preferably, the dry food composition comprises at least about 2.0% by weight of the coloring agent, such as from about 2.0% by weight to about 3.6% by weight (e.g., from about 2.5% by weight to about 3.0% by weight), based upon the total weight of the dry food composition taken as 100% by weight. The coloring agent is preferably titanium dioxide, which may be purchased commercially from Sensient Colors Inc. of St. Lewis, Mo., under the product number and name No. 03970 Kowet Titanium Dioxide, F.C.C. Grade, U.S.P. Grade, C.T.F.A. Grade.

The dry food composition may comprise at least one flavoring agent for providing a suitable flavor to the food product. The flavor provided to the food product may be any suitable flavor, such as marshmallow, vanilla, orange, lime, grapefruit, apple, pear, peach, strawberry, apricot, raspberry, cherry, plum, pineapple, or any other flavor, or combination of flavors. The flavoring agent may be any suitable flavoring agent, or combination of flavoring agents, which is capable of providing a desired flavor (e.g., marshmallow flavor). The flavoring agent for various embodiments of the present invention may include fruit juices which could supply liquid, sweetener, color, acidity, as well as flavor.

The total flavoring agent(s) present in the dry food composition is preferably at least about 0.06% by weight, such as from about 0.06% by weight to about 2.0% by weight, based upon the total weight of the dry food composition taken as 100% by weight. More preferably, the dry food composition comprises at least about 0.10% by weight total flavoring agent(s), such as from about 0.10% by weight to about 1.0% by weight, based upon the total weight of the dry food composition taken as 100% by weight. Most preferably, the dry food composition comprises at least about 0.20% by weight total flavoring agent(s), such as from about 0.20% by weight to about 0.40% by weight (e.g., from about 0.25% by weight to about 0.38% by weight or from about 0.30% by weight to about 0.35% by weight), based upon the total weight of the dry food composition taken as 100% by weight.

For various embodiments of the invention, the dry food composition more preferably includes flavoring agents comprising a marshmallow flavoring agent and a vanilla flavoring agent. The amount or quantity of marshmallow flavoring agent present in the food product is preferably at least about 0.04% by weight, such as from about 0.04% by weight to about 1.5% by weight, based upon the total weight of the dry food composition taken as 100% by weight. More preferably, the dry food composition comprises at least about 0.10% by weight marshmallow flavoring agent, such as from about 0.10% by weight to about 0.90% by weight, based upon the total weight of the dry food composition taken as 100% by weight. Most preferably, the food product comprises at least about 0.15% by weight marshmallow flavoring agent, such as from about 0.15% by weight to about 0.30% by weight (e.g., from about 0.20% by weight to about 0.28% by weight or from about 0.22% by weight to about 0.26% by weight), based upon the total weight of the dry food composition taken as 100% by weight. A suitable marshmallow flavoring agent may be purchased commercially from Master-Taste 6805 Tamarind Circle, Orlando, Fla. 32819 under the product name Artificial Marshmallow Flavor MC 005668.

The amount or quantity of vanilla flavoring agent present in the dry food composition is preferably at least about 0.02% by weight, such as from about 0.02% by weight to about 0.33% by weight, based upon the total weight of the dry food composition taken as 100% by weight. More preferably, the dry food composition comprises at least about 0.04% by weight vanilla flavoring agent, such as from about 0.04% by weight to about 0.20% by weight, based upon the total weight of the dry food composition taken as 100% by weight. Most preferably, the dry food composition comprises at least about 0.07% by weight vanilla flavoring agent, such as from about 0.07% by weight to about 0.13% by weight (e.g., from about 0.08% by weight to about 0.10% by weight or from about 0.090% by weight to about 0.098% by weight), based upon the total weight of the dry food composition taken as 100% by weight. A suitable vanilla flavoring agent may be purchased commercially from Mother Murphy's Laboratories,Inc. of Greensboro, N.C. under the product (flavor) No.: PB7695, S.D. N&A Vanilla Flavor.

The dry food composition may comprise optional ingredients, such as preservative and nutritional supplements. Any known preservative may be suitable, such as one or more preservatives selected from the group consisting of sorbates (e.g., potassium sorbate), propionates (e.g., calcium propionate), and benzoates (e.g., sodium benzoate). Any known nutritional supplements may be suitable, such as one or more vitamin supplements and/or mineral supplements.

For various embodiments of the invention, the dry food composition may be divided up into two or more portions. Each portion may be conveniently stored in hermetically sealed packets. The divided portions may each comprise essentially identical ingredients, or different ingredients which when combined provide or produce the whole dry food composition. The portions may sequentially be added to a suitable liquid for producing a food product. By way of example only, one portion may be added to the liquid and stirred, or otherwise agitated, until a generally homogeneous initial food mixture is produced. The time of stirring, or otherwise agitating, for producing a generally homogeneous initial liquid food mixture may be any suitable period of time, such as one ranging from about 10 seconds to about 5 minutes, more typically from about 1 to about 2 minutes. After a generally homogeneous initial liquid food mixture has been produced, another portion of the dry food composition may be added to the generally homogeneous initial liquid food mixture, followed by stirring or agitation for a suitable period of time (e.g., from about 10 secs. to about 5 mins.) until a generally homogeneous liquid food product has been produced. The generally homogeneous liquid food product may then be poured into suitable cavities of a mold for setting up and solidifying, which typically takes from about 2 minutes to about 10 minutes. A food product (e.g., pieces of a food product) is produced which then may be removed from the cavities of the mold and eaten as desired.

For embodiments of the present invention the dry food composition may be divided into a first portion and a second portion, with the first and second portions being respectively hermetically sealed in their own dedicated packet. The first portion may comprise the gelling agent, at least one protein, at least one sweetening agent, at least one binding agent, the chemical reagent, and at least one flavoring agent. The second portion may comprise at least one sweetening agent, the chemical gassing agent, at least one coloring agent, and the filler or bulking agent. Preferably, the chemical reagent (e.g., malic acid) and the chemical gassing agent (e.g., sodium bicarbonate) should remain separated until ready for mixing; thus, the chemical-reagent (e.g., malic acid) is part of the first portion and the chemical gassing agent (e.g., sodium bicarbonate) is part of the second portion. Preferably, the proteins should be hydrated prior to the sweetener. This is a reason why most of the sweeteners are in the second portion. The sweeteners that are in the first portion are there to provide aid in the protein hydration by separating the protein particles from each other. Preferably, the binding agent (e.g., tapioca starch) is in the first portion to aid in slowing down the hydration rate and give additional time to build viscosity. The coloring agent is preferably in the second portion.

The first portion is preferably mixed with the suitable liquid until blended to produce the generally homogeneous initial food mixture. The first portion in mixing combination with the liquid (based upon the total weight of the first portion and the liquid taken as 100% by weight) may comprise: (i) at least about 1% by weight (e.g., from about 1% by weight to about 20% by weight), preferably at least about 2% by weight (e.g., from about 2% by weight to about 10% by weight), more preferably at least about 6% by weight (e.g., from about 6% by weight to about 8% by weight), of the gelling agent; (ii) at least about 5% by weight (e.g., from about 5% by weight to about 30% by weight), preferably at least about 8% by weight (e.g., from about 8% by weight to about 20% by weight), more preferably at least about 10% by weight (e.g., from about 10% by weight to about 12% by weight), of at least one protein (when at least one protein comprises two proteins, such as whey protein isolate and egg white, the mixing proportion may include about 1 part by weight whey protein isolate to about 2 parts by weight egg white); (iii) at least about 5% by weight (e.g., from about 5% by weight to about 40% by weight), preferably at least about 10% by weight (e.g., from about 10% by weight to about 20% by weight), more preferably at least about 13% by weight (e.g., from about 13% by weight to about 15% by weight), of at least one sweetening agent (when at least one sweetening agent comprises two sweetening components, such as sucrose and fructose, the mixing proportion may include about 1 part by weight fructose to about 2.75 parts by weight sucrose); (iv) at least about 1% by weight (e.g., from about 1% by weight to about 20% by weight), preferably at least about 2% by weight (e.g., from about 2% by weight to about 10% by weight), more preferably at least about 4% by weight (e.g., from about 4% by weight to about 6% by weight), of the binding agent; (v) at least about 0.1% by weight (e.g., from about 0.1% by weight to about 4% by weight), preferably at least about 0.5% by weight (e.g., from about 0.5% by weight to about 2% by weight), more preferably at least about 0.6% by weight (e.g., from about 0.6% by weight to about 0.8% by weight), of the chemical reagent; (vi) at least about 0.05% by weight (e.g., from about 0.05% by weight to about 3% by weight), preferably at least about 0.1% by weight (e.g., from about 0.1% by weight to about 1.5% by weight), more preferably at least about 0.15% by weight (e.g., from about 0.15% by weight to about 0.3% by weight), of at least one flavoring agent (when at least one flavoring agent comprises two flavoring components, such as marshmallow flavor and vanilla flavor, the mixing proportion may include about 1 part by weight vanilla flavor to about 2.5 parts by weight marshmallow flavor); and (vii) at least about 10% by weight (e.g., from about 10% by weight to about 90% by weight), preferably at least about 20% by weight (e.g., from about 20% by weight to about 70% by weight, more preferably at least about 50% by weight (e.g., from about 50% by weight to about 60% by weight), of the liquid.

The second portion (based upon the total weight of the second portion taken as 100% by weight) may comprise: (i) at least about 40% by weight (e.g., from about 40% by weight to about 90% by weight), preferably at least about 50% by weight (e.g., from about 50% by weight to about 80% by weight), more preferably at least about 60% by weight (e.g., from about 60% by weight to about 70% by weight), of at least one sweetening agent (when at least one sweetening agent comprises two sweetening components, such as sucrose and fructose, the mixing proportion may include about 1 part by weight sucrose to about 1.2 parts by weight fructose); (ii) at least about 1.0% by weight (e.g., from about 1.0% by weight to about 12% by weight), preferably at least about 3.0% by weight (e.g., from about 3.0% by weight to about 8.0% by weight), more preferably at least about 4.0% by weight (e.g., from about 4.0% by weight to about 6.0% by weight), of the chemical gassing agent; (iii) at least about 1.0% by weight (e.g., from about 1.0% by weight to about 14.0% by weight), preferably at least about 2.0% by weight (e.g., from about 2.0% by weight to about 10.0% by weight), more preferably at least about 5% by weight (e.g., from about 5% by weight to about 7% by weight), of the coloring agent; and (iv) at least about 5% by weight (e.g., from about 5% by weight to about 50.0% by weight), preferably at least about 10% by weight (e.g., from about 10% by weight to about 40% by weight), more preferably at least about 20% by weight (e.g., from about 20% by weight to about 30% by weight), of the filler or bulking agent. The second portion is preferably mixed and blended with the generally homogeneous initial food mixture to produce a liquid food product.

Embodiments of the present invention will be illustrated by the following set forth examples which are being given by way of illustration only and not by way of any limitation. All materials and chemical compositions whose source(s) are not stated below are readily available from commercial suppliers, who are known to those artisans possessing skill in the art. All parameters such as concentrations, mixing proportions, temperatures, rates, compounds, etc., submitted in these examples are not to be construed to unduly limit the scope of the invention. The listed percents (%) were on a percent by dry weight basis. The % by weight on a wet basis was obtained after mixing the dry food composition with a suitable liquid, such as water. The % by weight on a wet basis was also on a basis where after the dry food composition had been mixed with the liquid, no particular dry ingredient(s) within the dry food composition had undergone any substantial reaction (or weight reduction process) with any of the other dry ingredients and/or the liquid. By way of example, the % by weight on a wet basis was after the dry chemical gassing agent (e.g., sodium bicarbonate) and the dry chemical reagent (e.g., malic acid) had been mixed with the liquid, but before the chemical gassing agent had interacted or reacted with the chemical reagent causing the release of chemical gas to aerate and expand the mixture of the dry food composition and the liquid into the food product. As gas evolves from the chemical gassing agent, a reaction is taking place between the chemical reagent and the chemical gassing agent, causing not only gas to evolve, but also the formation of other chemical compounds. Thus, the % by weight on a wet basis was the % by weight on a pure ingredient basis, where it was assumed that no reaction takes place between any of the ingredients or components when mixed with or dissolved in the liquid.

In the following set forth examples it is recognized that some tests which are applicable to human beings yield results which at best are merely qualitative results due to the subjective sensations of human subjects, especially the sensation of taste and texture. It is further recognized that subjective sensation may vary so substantially from individual to individual that it is difficult to delineate well defined, quantitative results. However, even though test results, such as taste and texture, are evidence of subjective sensation, it is believed that they are still of objective value.

### EXAMPLE 1

The ingredients for this Example were:

| | | % Wet | % Dry |
|---|---|---|---|
| Ingredient | Quantity | Ingredients | Basis |
| Packet #1 | | | |
| Cryogel FG/3P | 1.900 g | 5.304% | 9.126% |
| Gelatin | | | |
| Whey protein | 1.000 g | 2.792% | 4.803% |
| Isolate | | | |
| Egg White | 2.000 g | 5.583% | 9.606% |
| Solids | | | |
| EFG Sugar | 2.750 g | 7.677% | 13.208% |
| Crystallized | 1.000 g | 2.792% | 4.803% |
| Fructose | | | |
| Avebe 2030 | 1.500 g | 4.188% | 7.205% |
| Malic Acid | 0.200 g | 0.588% | 0.961% |
| Metarom | | | |
| Marshmallow | 0.050 g | 0.140% | 0.240% |
| Flavor | | | |
| Mother Murphy | 0.020 g | 0.056% | 0.096% |
| Vanilla Flavor | | | |
| Total Packet | 10.42 g | 29.09% | 50.05% |
| #1 | | | |
| Water | 15.00 g | 41.88% | |
| Packet #2 | | | |
| EFG Sugar | 3.000 g | 8.375% | 14.409% |
| Crystallized | 3.600 g | 10.05% | 17.291% |
| Fructose | | | |
| Titanium | 0.600 g | 1.675% | 2.882% |
| dioxide | | | |
| Corn syrup | 2.700 g | 7.538% | 12.968% |
| solids | | | |
| Sodium | 0.500 g | 1.396% | 2.402% |
| bicarbonate | | | |
| Total Packet | 10.40 g | 29.03% | 49.95% |
| #2 | | | |
| Total All | 35.82 g | 100.00% | 100.00% |
| Ingredients | | | |

In the foregoing Example 1 the coloring agent in the dry food composition was white for producing a white marshmallow product. All ingredients were mechanically milled to achieve a uniform particle size in each packet in accordance with the following milling standard: 100% by wt. through a 30-gauge USA Standard Sieve Screen, 65% by wt. minimum through a 50-gauge USA Standard Sieve Screen, and 85% by wt. minimum on a 140-gauge USA Standard Sieve Screen. The ingredients of packet no. 1 were initially mixed with and dissolved in warm water (i.e., a temperature from about 110° F. to about 115° F.). After dissolving and/or mixing (e.g., for about 1 to 3 minutes) the ingredients of packet no. 1 in the warm water, the ingredients of packet no. 2 were added to the mixed ingredients (i.e., the mixture of warm water and the ingredients of packet no. 1), followed by subsequent stirring for 1 to 3 minutes to produce a mixed product. After the mixed product was allowed to set for 5 to 15 minutes at ambient conditions, a food product was produced having a desired target with respect to taste, texture and mouth-feel. If the mixed product is refrigerated, the set time is reduced to around 5 minutes. The target was a light, soft, fluffy sweetened marshmallow-type confection produced without external heat. Flavor, texture and mouth-feel were developed to match Peeps™ marshmallow treat, manufactured by Just Born, Inc. in Bethlehem, Pa. While the formulation of this Example produced a desirable food product that performed in a manner to match the target, it is to be understood that the spirit and scope of the present invention would include other formulations which would match a desired target.

### EXAMPLE 2

The ingredients for this Example were:

| | | % Wet | % Dry |
|---|---|---|---|
| Ingredient | Quantity | Ingredients | Basis |
| Packet #1 | | | |
| Cryogel FG/3P | 1.823 g | 5.299% | 9.115% |
| Gelatin | | | |
| Whey protein | 0.960 g | 2.789% | 4.800% |
| Isolate | | | |
| Egg White | 1.919 g | 5.578% | 9.595% |
| Solids | | | |
| EFG Sugar | 2.639 g | 7.670% | 13.195% |
| Crystallized | 0.960 g | 2.789% | 4.800% |
| Fructose | | | |
| Avebe 2030 | 1.440 g | 4.184% | 7.200% |
| Malic Acid | 0.192 g | 0.558% | 0.960% |
| Metarom | | | |
| Marshmallow | 0.048 g | 0.139% | 0.240% |
| Flavor | | | |
| Mother Murphy | 0.019 g | 0.054% | 0.095% |
| Vanilla Flavor | | | |
| Total Packet | 10.00 g | 29.06% | 50.00% |
| #1 | | | |
| Water | 14.41 g | 41.88% | |
| Packet #2 | | | |
| EFG Sugar | 2.885 g | 8.383% | 14.425% |
| Crystallized | 3.462 g | 10.060% | 17.310% |
| Fructose | | | |
| Titanium | 0.577 g | 1.677% | 2.885% |
| dioxide | | | |
| Corn syrup | 2.596 g | 7.545% | 12.980% |
| solids | | | |
| Sodium | 0.481 g | 1.397% | 2.405% |
| bicarbonate | | | |
| Total Packet | 10.00 g | 29.06% | 50.00% |
| #2 | | | |
| Total All | 34.41 g | 100.00% | 100.00% |
| Ingredients | | | |

Two samples, Sample 2A and Sample 2B, of the subject dry food composition noted in the foregoing Example 2 were prepared. The ingredient particle sizes as received from the vendors for the dry ingredients in both packet 2A and packet 2B were as follows:

| Ingredient | USA Standard Sieve |
|---|---|
| Gelatin | Through 80 mesh - 95% minimum |
| Whey Protein | Through 80 mesh - 95% |
| Isolate | |
| Egg Albumen | Through 80 mesh - 100% |
| EFG Sugar | On 20 mesh - 4% max., on 40 mesh - 35-65% |
| | cumulative, through 40 mesh - 35-65% cumulative, |
| | through 100 mesh - 8% max. |
| Crystallized | On 20 mesh - 0.3% max., on 30 mesh 1.0% max., on |
| Fructose | 40 mesh - 20% max., on 60 mesh - 45% min - 75% |
| | max., through 100 mesh - 8% max. |
| Tapioca Starch | On 25 mesh - 5% max., through 140 mesh - 10% |
| | maximum |
| Malic Acid | On 25 mesh - 1% max., through 100 mesh - 5% max. |
| Marshmallow | On 50 mesh - 20% max., on 100 mesh - 25% max., |
| Flavor | through 140 mesh - 45% max. |
| Vanilla Flavor | On 50 mesh - 20% max., on 100 mesh - 35% max., |
| | through 140 mesh - 35% max. |
| Titanium | On 325 mesh - 0.5% maximum |
| Dioxide | |
| Corn Syrup | On 50 mesh - 11% max. |
| Solids | |
| Sodium | On 100 mesh - 0.3% max., on 200 mesh - 37.6% |
| Bicarbonate | cumulative max., through 325 mesh - 30.1% maximum |

All ingredients in Sample 2A were mechanically milled to achieve a uniform particle size in each packet in accordance with the following milling standard: 100% by wt. through a 30-gauge USA Standard Sieve Screen, 65% by wt. minimum through a 50-gauge USA Standard Sieve Screen, and 85% by wt. minimum on a 140-gauge USA Standard Sieve Screen. All Ingredients for Sample 2B were not milled.

Food products were prepared from Samples 2A and 2B in accordance with the procedure of Example 1 (e.g., using warm tap water having a temperature 110-115° F.). The food product produced from Sample 2A matched the standard of the food product produced in Example 1. It was light and fluffy in texture with a sweet marshmallow flavor. In the process of preparing a food product from Sample 2B, it took longer to mix, and all the ingredients were not completely dissolved due to the particle size of Sample 2B. Also, using the same mold cavities as the food product produced from Sample 2A, the gas (air) volume of the food product from Sample 2B was smaller and yielded smaller pieces than the food product from Sample 2A. The finished pieces were grainy from undissolved sugar with defined “fish eyes” or undissolved pieces of gelatin. Therefore, if the products are not milled to a standard size, when the packets are mixed together with the water, some of the particles will not completely dissolve. Most notably will be the sweeteners, the gelatin, the flavors, and the acid. The sweeteners will be apparent as a gritty texture indicative of granular sugar. The gelatin will appear as “fish eyes” or undissolved bits of gelatinous material. The flavors will be visible as large pieces of neutral colored flakes and bits. The acid will be apparent as a sharp taste and functionally will be the cause of the reduced volume yield. If the acid does not dissolve, it cannot react with the sodium bicarbonate to create the gas.

### EXAMPLE 3

The ingredients for this Example were:

| | | % Wet | % Dry |
|---|---|---|---|
| Ingredient | Quantity | Ingredients | Basis |
| Packet #1 | | | |
| Cryogel FG/3P | 2.180 g | 6.272% | 10.78% |
| Gelatin | | | |
| Whey protein | 0.925 g | 2.661% | 4.574% |
| Isolate | | | |
| Egg White | 1.850 g | 5.322% | 9.148% |
| Solids | | | |
| EFG Sugar | 2.600 g | 7.480% | 12.857% |
| Crystallized | 0.850 g | 2.445% | 4.203% |
| Fructose | | | |
| Avebe 2030 | 1.400 g | 4.028% | 6.923% |
| Malic Acid | 0.350 g | 1.007% | 1.731% |
| Metarom | | | |
| Marshmallow | 0.048 g | 0.138% | 0.237% |
| Flavor | | | |
| Mother Murphy | 0.019 g | 0.054% | 0.094% |
| Vanilla Flavor | | | |
| Total Packet | 10.22 g | 29.407% | 50.54% |
| #1 | | | |
| Water | 14.54 g | 41.83% | |
| Packet #2 | | | |
| EFG Sugar | 2.770 g | 7.969% | 13.698% |
| Crystallized | 3.350 g | 9.638% | 16.566% |
| Fructose | | | |
| Titanium | 0.550 g | 1.582% | 2.720% |
| dioxide | | | |
| Corn syrup | 2.500 g | 7.192% | 12.363% |
| solids | | | |
| Sodium | 0.830 g | 2.388% | 4.104% |
| bicarbonate | | | |
| Total Packet | 10.00 g | 28.77% | 49.45% |
| #2 | | | |
| Total All | 34.76 g | 100.00% | 100.00% |
| Ingredients | | | |

The purpose for Example 3 was to study the effects of elevating the respective ingredient levels of gelatin, malic acid, and, sodium bicarbonate from those ingredient levels of Example 1. Elevated ingredient levels were defined as an increase: in gelatin from about 9.126% to about 10.78%, in malic acid from about 0.96% to about 1.73%, and in sodium bicarbonate from about 2.4% to about 4.10% on a dry basis. A food product was prepared. in accordance with the procedure of Example 1 (e.g., using warm tap water having a temperature 110-115° F.). The food product produced did not match the standard of the food product produced in Example 1. During preparation the mixture developed gas (air) volume quicker and at a greater capacity than during the preparation of the product of Example 1. The mixture began to set prior to dispensing into molded cavities. Final food product pieces were larger in size, but fewer in number than the food product of Example 1. Final food product texture was firmer and more rubbery than desired when compared to the food product of Example 1.

### EXAMPLE 4

The ingredients for this Example were:

| | | % Wet | % Dry |
|---|---|---|---|
| Ingredient | Quantity | Ingredients | Basis |
| Packet #1 | | | |
| Cryogel FG/3P | 1.475 g | 4.286% | 7.375% |
| Gelatin | | | |
| Whey protein | 1.000 g | 2.906% | 5.000% |
| Isolate | | | |
| Egg White | 1.950 g | 5.666% | 9.750% |
| Solids | | | |
| EFG Sugar | 2.890 g | 8.398% | 14.450% |
| Crystallized | 1.150 g | 3.342% | 5.750% |
| Fructose | | | |
| Avebe 2030 | 1.450 g | 4.213% | 7.250% |
| Malic Acid | 0.020 g | 0.058% | 0.100% |
| Metarom | | | |
| Marshmallow | 0.048 g | 0.139% | 0.240% |
| Flavor | | | |
| Mother Murphy | 0.019 g | 0.055% | 0.095% |
| Vanilla | | | |
| Flavor | | | |
| Total Packet | 10.00 g | 29.06% | 50.010% |
| #1 | | | |
| Water | 14.41 g | 41.87% | |
| Packet #2 | | | |
| EFG Sugar | 2.950 g | 8.572% | 14.750% |
| Crystallized | 3.600 g | 10.461% | 18.000% |
| Fructose | | | |
| Titanium | 0.587 g | 1.706% | 2.935% |
| dioxide | | | |
| Corn syrup | 2.850 g | 8.282% | 14.250% |
| solids | | | |
| Sodium | 0.015 g | 0.044% | 0.075% |
| bicarbonate | | | |
| Total Packet | 10.00 g | 29.06% | 50.010% |
| #2 | | | |
| Total All | 34.41 g | 100.00% | 100.020% |
| Ingredients | | | |

The purpose for Example 4 was to study the effects of decreasing the respective ingredient levels of gelatin, malic acid, and sodium bicarbonate from those ingredient levels of Example 1. Decreased ingredient levels were defined as a decrease: in gelatin from about 9.126% to about 7.38%, in malic acid from about 0.96% to about 0.10%, and in sodium bicarbonate from about 2.4% to about 0.0750% on a dry basis. A food product was prepared in accordance with the procedure of Example 1 (e.g., using warm tap water having a temperature 110-115° F.). The food product produced did not match the standard of the food product produced in Example 1. During preparation the mixture created almost no air volume when blended. The mixture was thin and watery when poured into molded cavities. Set-up time was longer than for the food product of Example 1. Final food product released easily from the molded cavities, but the pieces were smaller and denser with a doughy texture in comparison to the food product of Example 1.

### EXAMPLE 5

The ingredients for this Example were:

| | | % Wet | % Dry |
|---|---|---|---|
| Ingredient | Quantity | Ingredients | Basis |
| Packet #1 | | | |
| Cryogel FG/3P | 1.823 g | 5.299% | 9.117% |
| Gelatin | | | |
| Whey protein | 0.960 g | 2.789% | 4.798% |
| Isolate | | | |
| Egg White | 1.919 g | 5.578% | 9.597% |
| Solids | | | |
| EFG Sugar | 2.639 g | 7.670% | 13.196% |
| Crystallized | 0.960 g | 2.789% | 4.798% |
| Fructose | | | |
| Avebe 2030 | 1.440 g | 4.184% | 7.198% |
| Malic Acid | 0.192 g | 0.558% | 0.960% |
| Metarom | | | |
| Marshmallow | 0.048 g | 0.139% | 0.240% |
| Flavor | | | |
| Mother Murphy | 0.019 g | 0.054% | 0.096% |
| Vanilla Flavor | | | |
| Total Packet | 10.00 g | 29.06% | 50.00% |
| #1 | | | |
| Water | 14.41 g | 41.88% | |
| Packet #2 | | | |
| EFG Sugar | 2.885 g | 8.383% | 14.423% |
| Crystallized | 3.462 g | 10.060% | 17.308% |
| Fructose | | | |
| Titanium | 0.577 g | 1.677% | 2.885% |
| dioxide | | | |
| Corn syrup | 2.596 g | 7.545% | 12.981% |
| solids | | | |
| Sodium | 0.481 g | 1.397% | 2.404% |
| bicarbonate | | | |
| Total Packet | 10.00 g | 29.06% | 50.00% |
| #2 | | | |
| Total All | 34.41 g | 100.00% | 100.00% |
| Ingredients | | | |

The purpose of Example 5 was to illustrate the effects of varying the temperature of the water in the preparation of the food product. Three samples, Sample 5A, Sample 5B and Sample 5C, of the subject dry food composition were prepared. Each of the three samples contained the identical ingredients of that in Example 1. All ingredients in Sample 5A, Sample 5B, and Sample 5C were mechanically milled to achieve a uniform particle size in each packet in accordance with the following milling standard: 100% by wt. through a 30-gauge USA Standard Sieve Screen, 65% by wt. minimum through a 50-gauge USA Standard Sieve Screen, and 85% by wt. minimum on a 140-gauge USA Standard Sieve Screen.

A food product was produced from Sample 5A in accordance with the procedure (e.g., a water temperature of 110-115° F.) of Example 1. The food product produced from Sample 5A matched the standard of the food product of Example 1.

A food product was produced from Sample 5B in accordance with the procedure of Example 1, except the temperature of the water was from about 150° F. to about 160° F. The food product produced from Sample 5B did not match the standard of the food product produced from Sample 5A. During preparation the mixture of Packet no. 1 took longer to dissolve, and the final food product did not yield as much gas (air) volume in the final food pieces as that food product produced from Sample 5A. Also, the food pieces of the food product produced from Sample 5B were smaller than those achieved by Sample 5A. Most importantly, the hot water used to produce the food product from Sample 5B was a scalding (safety) hazard for users. Hot water is not a requirement for the formulation of a food product from the embodiments of the dry food composition of the present invention, due to the cold water activated gelatin and the cold water swelling starch (i.e., the binding agent).

A food product was produced from Sample 5C in accordance with the procedure of Example 1, except the temperature of the water was from about 70° F. to about 80° F. The food product produced from Sample 5C did not match the standard of the food product produced from Sample 5A. A very gelatinous mixture was produced when the water was added to Packet no. 1. The gelatin dissolved very quickly and completely. When Packet no. 2 was added to the mixture containing Packet no. 1 and the water, more (i.e., too much) gas (air) was produced compared to that produced during preparation of Sample 5A and Sample 5B. The food product set-up too fast to decant from the mixing container into mold cavities. The final food product did not release from the mold cavities.

### EXAMPLE 6

The ingredients for this Example were:

| | | % Wet | % Dry |
|---|---|---|---|
| Ingredient | Quantity | Ingredients | Basis |
| Packet #1 | | | |
| Cryogel FG/3P | 1.823 g | 5.299% | 9.115% |
| Gelatin | | | |
| Whey protein | 0.960 g | 2.789% | 4.800% |
| Isolate | | | |
| Egg White | 1.919 g | 5.578% | 9.595% |
| Solids | | | |
| EFG Sugar | 2.639 g | 7.670% | 13.195% |
| Crystallized | 0.960 g | 2.789% | 4.800% |
| Fructose | | | |
| Avebe 2030 | 1.440 g | 4.184% | 7.200% |
| LACTIC Acid | 0.192 g | 0.558% | 0.960% |
| Metarom | | | |
| Marshmallow | 0.048 g | 0.139% | 0.240% |
| Flavor | | | |
| Mother Murphy | 0.019 g | 0.054% | 0.095% |
| Vanilla Flavor | | | |
| Total Packet | 10.00 g | 29.06% | 50.00% |
| #1 | | | |
| Water | 14.41 g | 41.88% | |
| Packet #2 | | | |
| EFG Sugar | 2.885 g | 8.383% | 14.425% |
| Crystallized | 3.462 g | 10.060% | 17.310% |
| Fructose | | | |
| Titanium | 0.577 g | 1.677% | 2.885% |
| dioxide | | | |
| Corn syrup | 2.596 g | 7.545% | 12.980% |
| solids | | | |
| Sodium | 0.481 g | 1.397% | 2.405% |
| bicarbonate | | | |
| Total Packet | 10.00 g | 29.06% | 50.00% |
| #2 | | | |
| Total All | 34.41 g | 100.00% | 100.00% |
| Ingredients | | | |

The purpose of Example 6 was to illustrate the effects of replacing malic acid with lactic acid. The ingredients for the dry food substitution for Example 1 were used, except malic acid was replaced with lactic acid on 1 for 1% by weight substitution basis (i.e., the % by weight of lactic acid used was 0.96%, which was the same % by weight of malic acid used in Example 1). A food product was prepared in accordance with the procedure of Example 1 (e.g., using warm tap water having a temperature 110-115° F.). The food product produced did not match the standard of the food product produced in Example 1. While the mixture blended well during preparation, there was a larger volume of gas (air) created than during the preparation of the food product of Example 1. The mixture set-up too fast, which did not allow adequate time for pouring the mixture from the container into the mold cavities. The final food product contained larger and fewer food pieces. The final product also was tacky and had a slightly salty taste when compared to food product of Example 1.

### EXAMPLE 7

The ingredients for this Example were:

| | | % Wet | % Dry |
|---|---|---|---|
| Ingredient | Quantity | Ingredients | Basis |
| Packet #1 | | | |
| Cryogel FG/3P | 1.823 g | 5.299% | 9.115% |
| Gelatin | | | |
| Whey protein | 0.960 g | 2.789% | 4.800% |
| Isolate | | | |
| Egg White | 1.919 g | 5.578% | 9.595% |
| Solids | | | |
| EFG Sugar | 2.639 g | 7.670% | 13.195% |
| Crystallized | 0.960 g | 2.789% | 4.800% |
| Fructose | | | |
| Avebe 2030 | 1.440 g | 4.184% | 7.200% |
| CITRIC Acid | 0.192 g | 0.558% | 0.960% |
| Metarom | | | |
| Marshmallow | 0.048 g | 0.139% | 0.240% |
| Flavor | | | |
| Mother Murphy | 0.019 g | 0.054% | 0.095% |
| Vanilla Flavor | | | |
| Total Packet | 10.00 g | 29.06% | 50.00% |
| #1 | | | |
| Water | 14.41 g | 41.88% | |
| Packet #2 | | | |
| EFG Sugar | 2.885 g | 8.383% | 14.425% |
| Crystallized | 3.462 g | 10.060% | 17.310% |
| Fructose | | | |
| Titanium | 0.577 g | 1.677% | 2.885% |
| dioxide | | | |
| Corn syrup | 2.596 g | 7.545% | 12.980% |
| solids | | | |
| Sodium | 0.481 g | 1.397% | 2.405% |
| bicarbonate | | | |
| Total Packet | 10.00 g | 29.06% | 50.00% |
| #2 | | | |
| Total All | 34.41 g | 100.00% | 100.00% |
| Ingredients | | | |

The purpose of Example 7 was to illustrate the effects of replacing malic acid with citric acid. The ingredients for the dry food substitution for Example 1 were used, except malic acid was replaced with citric acid on 1 for 1% by weight substitution basis (i.e., the % by weight of citric acid used was 0.96%, which was the same % by weight of malic acid used in Example 1). A food product was prepared in accordance with the procedure of Example 1 (e.g., using warm tap water having a temperature 110-115° F.). The food product produced did not match the standard of the food product produced in Example 1. During preparation, the mixture was comparable to (and had the characteristics of) the mixture of Example 1 where malic acid was used, particularly with respect to mixing, mix time required, air volume achieved, and the number and size of pieces yielded from the preparation process. However, the final product had a very defined salty, unacceptable taste when compared to food product of Example 1.

### EXAMPLE 8

The ingredients for this Example were:

| | | % Wet | % Dry |
|---|---|---|---|
| Ingredient | Quantity | Ingredients | Basis |
| Packet #1 | | | |
| Cryogel FG/3P | 1.823 g | 5.299% | 9.115% |
| Gelatin | | | |
| Whey protein | 0.960 g | 2.789% | 4.800% |
| Isolate | | | |
| Egg White | 1.919 g | 5.578% | 9.595% |
| Solids | | | |
| Maltitol | 2.639 g | 7.670% | 13.195% |
| Maltitol | 0.960 g | 2.789% | 4.800% |
| Avebe 2030 | 1.440 g | 4.184% | 7.200% |
| Malic Acid | 0.192 g | 0.558% | 0.960% |
| Metarom | | | |
| Marshmallow | 0.048 g | 0.139% | 0.240% |
| Flavor | | | |
| Mother Murphy | 0.019 g | 0.054% | 0.095% |
| Vanilla Flavor | | | |
| Total Packet | 10.00 g | 29.06% | 50.00% |
| #1 | | | |
| Water | 14.41 g | 41.88% | |
| Packet #2 | | | |
| Maltitol | 2.885 g | 8.383% | 14.425% |
| Maltitol | 3.462 g | 10.060% | 17.310% |
| Titanium | 0.577 g | 1.677% | 2.885% |
| dioxide | | | |
| Corn syrup | 2.596 g | 7.545% | 12.980% |
| solids | | | |
| Sodium | 0.481 g | 1.397% | 2.405% |
| bicarbonate | | | |
| Total Packet | 10.00 g | 29.06% | 50.00% |
| #2 | | | |
| Total All | 34.41 g | 100.00% | 100.00% |
| Ingredients | | | |

The purpose of Example 8 was to illustrate the effects of replacing EFG sugar with maltitol and replacing crystalline fructose with maltitol. The ingredients for the dry food substitution for Example 1 were used, except EFG sugar was replaced with maltitol on a 1 for 1% by weight substitution basis, and crystalline fructose was replaced with maltitol on a 1 for 1% by weight substitution. Thus, for packet no. 1, 13.2% by weight of the EFG sugar was correspondingly replaced with 13.2% by weight maltitol, and 4.8% by weight of crystallized fructose was correspondingly replaced with 4.8% by weight maltitol. Similarly for packet no. 2, 14.4% by weight of the EFG sugar was correspondingly replaced with 14.4% by weight maltitol, and 17.3% by weight of crystallized fructose was correspondingly replaced with 17.3% by weight maltitol.

A food product was prepared in accordance with the procedure of Example 1 (e.g., using warm tap water having a temperature 110-115° F.). During preparation, the mixture did not yield as much gas (air) volume as that achieved with sugar and fructose in the food product of Example 1. The food product was quick to set-up with good flavor and texture. There was some tackiness, but overall the final product produced in accordance with this Example was a very favorable, lightly sweet product that was slightly more dense than the food product of Example 1.

### Conclusion

While the present invention has been described herein with reference to particular embodiments thereof, a latitude of modifications, various changes and substitutions are intended in the foregoing disclosure, and it will be appreciated that in some instances some features of the invention will be employed, without a corresponding use of other features without departing from the scope and spirit of the invention as set forth. Therefore, many modifications may be made to adapt a particular situation or material to the teachings of the invention without departing from the essential scope and spirit of the present invention. It is intended that the invention not be limited to the particular embodiment disclosed as the best mode contemplated for carrying out this invention, but that the invention will include all embodiments and equivalents falling within the scope of the appended claims.

1. A dry particulate food composition comprising a gelling agent, at least one protein, at least one binding agent, at least one sweetening agent, a chemical gassing agent, and a chemical reagent for controlling and increasing a quantity of chemical gas released from the chemical gassing agent.

2. The dry particulate food composition of claim 1 additionally comprising at least one flavoring agent, at least one bulking agent, and at least one coloring agent.

3. The dry particulate food composition of claim 1 wherein said gelling agent comprises at least about 3% by weight of the dry particulate food composition.

4. The dry particulate food composition of claim 1 wherein said protein is selected from the group consisting of whey protein, soy protein, and egg albumen.

5. The dry particulate food composition of claim 1 wherein said protein comprises at least about 1% by weight egg albumen of the dry particulate food composition, and at least about 1% by weight whey protein isolate of the dry particulate food composition.

6. The dry particulate food composition of claim 1 wherein said protein comprises whey protein isolate combined with egg albumen in a weight ratio ranging from about 1:1 to about 1:3.

7. The dry particulate food composition of claim 1 wherein said chemical reagent comprises at least about 0.1% by weight of the dry particulate food composition.

8. The dry particulate food composition of claim 1 wherein said chemical gassing agent comprises at least about 0.2% by weight of the dry particulate food composition.

9. The dry particulate food composition of claim 1 wherein said binding agent comprises at least about 1.0% by weight of the dry particulate food composition.

10. The dry particulate food composition of claim 1 wherein said sweetening agent comprises at least about 20% by weight of the dry particulate food composition.

11. The dry particulate food composition of claim 1 wherein said sweetening agent comprises at least about 25.0% by weight of a first sweetening component of the dry particulate food composition, and at least about 10.0% by weight of a second sweetening component of the dry particulate food composition.

12. A method for producing a food product comprising:
providing a dry particulate food composition including a gelling agent, at least one protein, at least one binding agent, at least one sweetening agent, a chemical gassing agent, and a chemical reagent for controlling and increasing a quantity of chemical gas released from the chemical gassing agent; and
adding the dry particulate food composition to a liquid to produce a food product.

13. The method of claim 12 wherein said liquid comprises a temperature ranging from about 105° F. to about 120° F.

14. The method of claim 12 additionally comprising producing said food product without employing external heat.

15. A food product produced in accordance with the method of claim 12.

16. A method for producing a food product comprising:
providing a first dry particulate food composition including a gelling agent, at least one protein, at least one binding agent, at least one sweetening agent, and a chemical reagent for controlling and increasing a quantity of chemical gas released from a chemical gassing agent;
adding the first dry particulate food composition to a liquid to produce a liquid food mixture; and
adding a chemical gassing agent to the liquid food mixture to produce a food product.

17. A food product produced in accordance with the method of claim 16.

18. A method for producing a food composition comprising:
providing particulates of a sweetening agent and particulates of an agent for controlling the release of chemical gas from a chemical gassing agent;
separating from the dehydrated sweetening particulates sweetening particles having an average particle size less than about 600 μM, leaving residual dehydrated sweetening particles having an average particle size equal to or greater than about 600 μM;
separating from the particulates of the agent for controlling the release of chemical gas from a chemical gassing agent agent particles having an average particle size less than about 600 μM, leaving residual agent particles having an average particle size equal to or greater than about 600 μM; and
mixing the separated agent particles and separated sweetening particles together to produce a food composition.

19. A dry food composition comprising a plurality of particulates having an average particle size less than about 600 μM and including a gelling agent, at least one binding agent, at least one protein, at least one sweetening agent, a chemical gassing agent, and a chemical reagent for controlling and increasing a quantity of chemical gas released from the chemical gassing agent.
